(19) United States
(12) Patent Application Publication
(10) Pub. No.: US 2007/0204013 A1
(43) Pub. Date: Aug. 30, 2007

(54) Method and apparatus for creating a website

(76) Inventor: David P. Castrucci, South Burlington, VT (US)

Correspondence Address: JOHN MAIER, III, 660 Aaron Court, Kingstone, NY, 12401, US

(21) Appl. No.: 11/652,300

(22) Filed: Jan. 11, 2007

Related U.S. Application Data
(60) Provisional application No. 60/758,378, filed on Jan. 12, 2006.

(51) Int. Cl. G06F 15/16

(52) U.S. Cl. 709/219

(57) ABSTRACT

An apparatus is provided for use in conjunction with the Internet for creating web sites. A host server includes an administrative application, the sever application being connected to the administrative application. Host storage is provided for retaining design elements. A host database is connected to the server application and to both the server application and to both the host data base and to the host storage. A local computer is connected by the Internet to the host server, the local computer. The local computer includes an Internet browser for displaying designs composed by the server application. A site designer provides the ability to modify site designs. Local storage is provided for the retention of modifications. Administrative access is utilized for managing stored designs. An Internet connection is made between the host server and the local computer. A method also provides for creating a website utilizing the Internet from a host computer for a local computer. Storing a selection of design elements in the host computer. Selecting specific design elements. Transmitting the selected design elements to the local computer. Modifying the selected design elements on the local computer and storing in the local computer any modifications to the design elements.

### RELATED APPLICATIONS

This application claims priority based upon Provisional Application No. 60/758,378 filed Jan. 12, 2006 and entitled Method and Apparatus For Creating Advanced Website Deigns.

### BACKGROUND OF THE INVENTION

1. Field of the Invention

This invention relates to websites such as are used on the Internet and, more particularly, to a method and apparatus for creating such websites.

2. Prior Art

Web site creation has been a standard process for greater than 10 years. It started with the raw creation of HTML files that were interlinked together with page links and uploaded to a server to run the website. It then grew into 2 distinct areas. One was tools that were powerful webpage creators but still used the same process and the second are mini non powerful website layout systems that connect directly to the server. These 2 technologies have limitations and do not allow the fast and dynamic and powerful creation of websites by non technical individuals. The 1^{st} forces the user to generate code to apply designs and functions running on a server with a database. The second limits the user's ability to create custom designs running custom layouts and custom structures. An apparatus and method that permits the selection by persons not specifically skilled in the construction of websites of definable and reconfigurable dynamic blocks from a host computer, it is possible to construct a website that provides economic and time savings in the production of a display of complex websites. In essence, such an apparatus and method would permit the creation of a dynamic website design, structure and function without the person creating the website having any advanced programming skill.

### OBJECTS

Accordingly, the objects of this invention are to provide a method and apparatus for constructing website as follows:
1. That can be readily constructed by one of limited skill by the use of dynamic blocks selected from a host computer.
2. That can be efficiently and economically provided.
3. That is dependable to consistently provide a high-quality complex website.
4. That is reconfigurable.
5. That when the page is requested from the computer the dynamic blocks generate content, format content, run applications and assemble together based on group information including but not limited to relative location information.

### SUMMARY

An apparatus is provided for use in conjunction with the Internet for creating web sites. A host server includes an administrative application, the sever application being connected to the administrative application. Host storage is provided for retaining design elements. A host database is connected to the server application and to both the host data base and to the host storage. A local computer is connected by the Internet to the host server. The local computer includes an Internet browser for displaying designs composed by the server application. The administrative application provides the ability to modify site designs. Local storage is provided for the retention of modifications. Administrative access is utilized for managing stored designs. An Internet connection is made between the host server and the local computer.

A method is also provided for creating a website utilizing the Internet from a host computer for a local computer. Storing a selection of design elements in the host computer. Selecting specific design elements. Transmitting the selected design elements to the local computer. Modifying the selected design elements on the local computer and storing in the local computer any modifications to the design elements.

### BRIEF DESCRIPTION OF THE DRAWINGS

FIG. 1 is a schematic view of the apparatus and method including the interconnection between a host server and a local computer.

FIG. 2 is a schematic view showing the various components within the host server.

FIG. 3 is a template layout.

FIG. 4 is a page layout of the host hot metal formatting language for displaying information.

FIG. 5 shows a block property menu.

FIG. 6 shows a page block configuration menu.

FIG. 7 shows a dynamic block type menu.

### BRIEF DESCRIPTION OF THE NUMERALS

| NUMERAL | DESCRIPTION |
|---|---|
| 11 | Local Computer |
| 13 | Host Server |
| 15 | Internet |
| 17 | Internet Browser |
| 18 | Administrative Access Software |
| 19 | Server Application |
| 21 | Host Storage |
| 23 | Host Database |
| 25 | Site Designer |
| 27 | Local Storage |
| 29 | Administration Application |
| 31 | HTML (Hot Metal Formatting language Display) |
| 33 | Page Request |
| 35 | Template |
| 37 | Blocks |
| 39 | Heater Block |
| 41 | Functions |
| 43 | Engines |
| 45 | Cascading Style Sheets |
| 47 | Tag Definitions |
| 49 | Graphical User Interface |
| 51 | Static Blocks |
| 53 | Dynamic Blocks |
| 57 | Block Property Menu |
| 59 | Tabs |
| 61 | Attribute Controls |
| 63 | Value Field Selection |
| 65 | Attribute Value |
| 69 | Dialog Menu |
| 71 | Page Block Setup Menu |
| 73 | Page Template Select |
| 75 | Block Select |
| 77 | Block ID (Identification) |
| 79 | Block Name |
| 81 | Block Dialog Menu |
| 83 | Block Function |
| 85 | Block Type |
| 87 | Block Entity |
| 89 | Block Parameter |
| 91 | Block Description |

### DETAILED DESCRIPTION OF THE PREFERRED EMBODIMENT

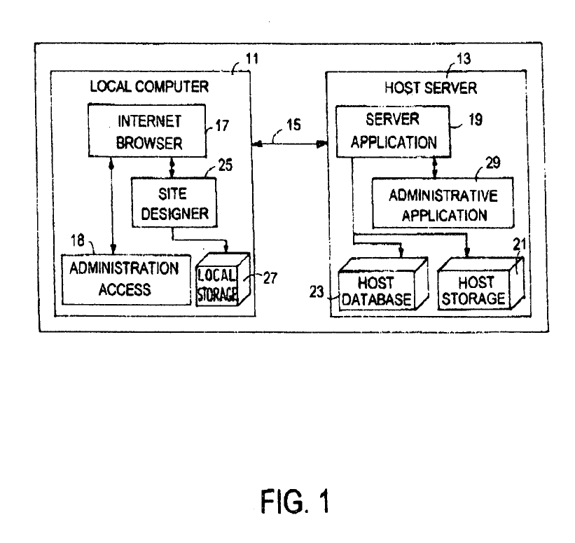

This invention provides a system (FIG. 1) that runs on a local computer 11 and a host server 13 connected over the Internet 15. The Internet Browser 17 software running on the Administrative Access software 18 the within the Local Computer 11 makes a call for an address supported by a server application 19. Where these calls are for general website requests, the server application 19, running on the host server 13, assembles the elements and content from the website design available from within a host storage 21, host database 23 and other sources accessible via a multiplicity of connections on the Internet 13. These elements and content available from within the host storage 21 are composed by the server application 19 and are then returned to the Internet Browser 17 for display.

A site designer 25 provides tools for the authorized user to create or modify site designs. These modifications can be stored on the local storage 27 within the local computer 11 or on a host computer 21 within the host server 13 or both. Stored designs can be managed through administrative access 18 displayed by the internet browser 17 which is called through the server application 19 and processed within an administrative application 29 running on the host server 13. The hardware architecture can vary dependent upon available technology and capacity requirements. These variations could include, but not be limited to, mirrored servers and data base systems, firewall schemes, routers and network system messaging.

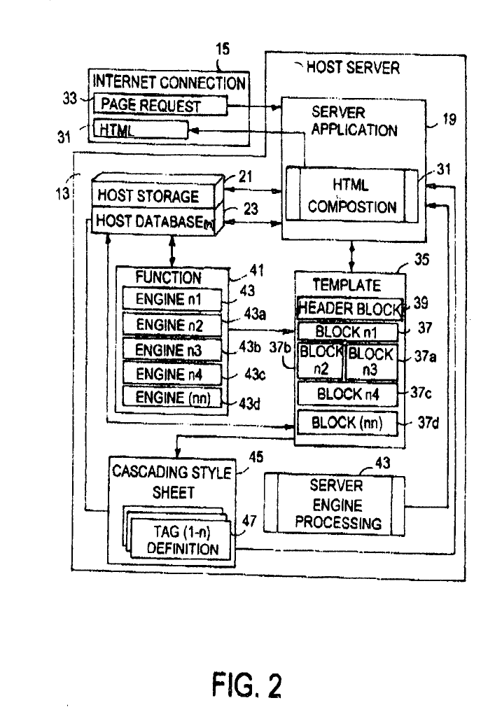

The architecture of the data flow within the host server 13 (FIG. 2) allows this method and apparatus dynamically to compose attributes, function and content data entered by the users or acquired from other sources into web page and hot metal formatting language displaying information in accordance with the components within the host storage 21 and the host database 23 or other sources accessible via a multiplicity of connections on the Internet 15.

A page request 33 in the form of a Uniform Resource Locator (URL) or other addressing scheme entering the host server 13 through a connection on the Internet 15 and is forwarded to the server application 19. The server application 19 locates the address of the Uniform Resource Locator in the database and retrieves resources specific to the properties assigned. Included within these properties is a template 35. Each template 35 contains an assembly of blocks 37 that define the specific attributes, and layout designations of the Uniform Resource Locator. These blocks 37 can consist of fixed content, such as in the case of the header block 39 or they can correspond to functions 41 in the form of engines 43 which provide the specific operations of various features. Once the server application 19 has assembled the content according to the template 35 from the host storage 21, the host database 23 and the engines 43, invoke the respective cascading style sheets 45 to the blocks 37 and their related tag definitions 47and the server application 19, builds the hot metal formatting language display 31 dynamically. The completed hot metal formatting language display 31 is sent through the Internet 15 to the local computer 11 as a reply to the original page request 33.

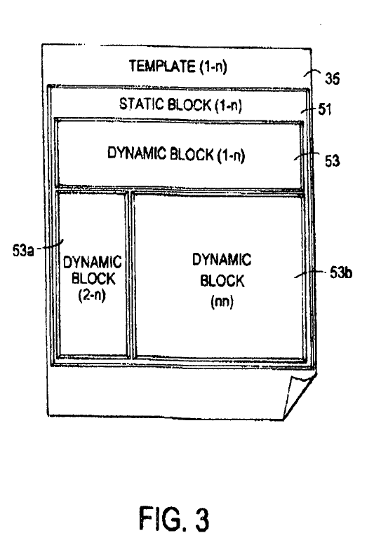

The layout of the blocks 37 and their settings are specified within a graphical user interface 49 of the site designer 25. Web page elements are hierarchically ordered in the template 35, which contains one or more static blocks 51 and each static block may contain one or more dynamic blocks 53. A representation of the page layout (FIG. 3) by means of the graphical user interface 49 provides reference for assembled and edited site design.

Control of all aspects of content, including source, format and function is managed through the blocks 37. The initial function of the static blocks 51 or the dynamic blocks 53 is to establish page positioning of content in relationship to other content on the page.

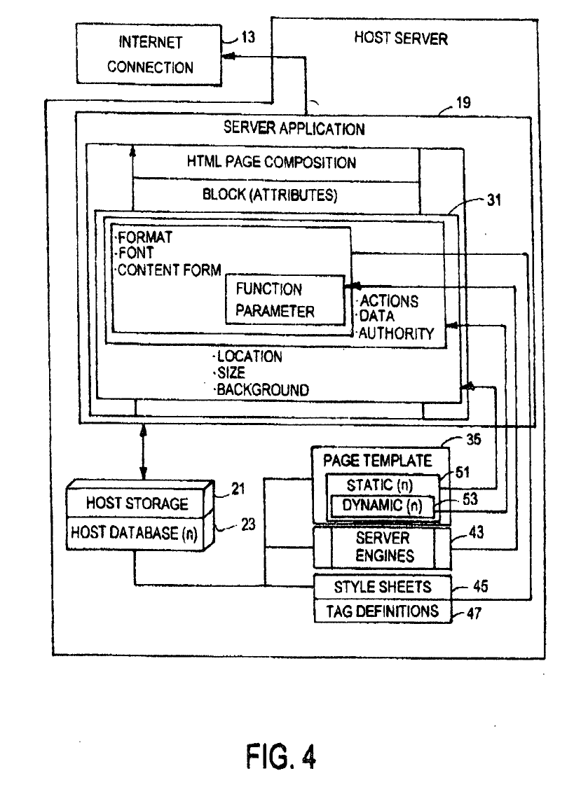

During page composition of the (FIG. 4) hot metal or other form of display language 31 for displaying information, the web page is dynamically assembled from a design specifically related to current data and user parameters. This is accomplished within the server application 19 by combining the information from elements indicated within the template 35 and its relationship to cascading style sheets 45 and processing from any specified server engine 43, respective to the static blocks 51 and dynamic blocks 53.

These aspects of content within page design are specified within the graphical user interface 49 of the site designer 25. In the case of a static block 51, the aspects of the content are related to those commonly associated with formatting, including but not limited to size, position, background, borders, padding, fonts and image files. These attributes are entered or changed (FIG. 5) through a block property menu 57 consisting of one or more tabs 59 that logically group display attribute selections containing a variety of attribute controls 61. These attribute controls 61 utilize tools such as pull downs, scrolls and select windows which dynamically change according to an attribute value field selection 63 to provide appropriate attribute value 65 through any variation of graphical user interfaces 49 to adjust the tag definitions 47 of cascading style sheets 45 and variable options that will be used by the method and apparatus to compose the web page. In addition to these common attributes, the block property menu 57 contains a name and identification to distinguish each instance from any others within the host database 23.

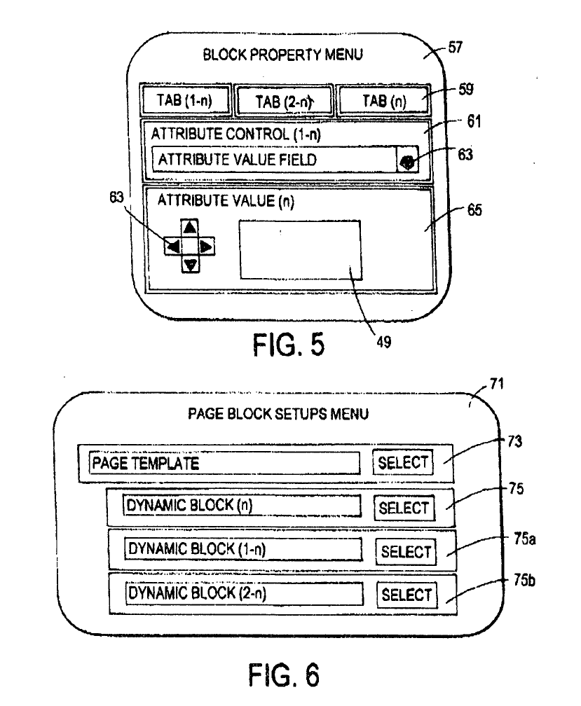

Dynamic blocks 53 have additional attributes that add function and database content options providing more flexibility and control over page designs, through further configuration. For each dynamic block 53 assigned to a web page can be defined with specific characteristic or page properties through the block menu 71 as shown in (FIG. 6) by indicating the page template 73 and a block select 75 displaying the block identification 77 distinguishing one from the other within the host database 23. The name given to each block 37 will be displayed as the block name 79 for future reference.

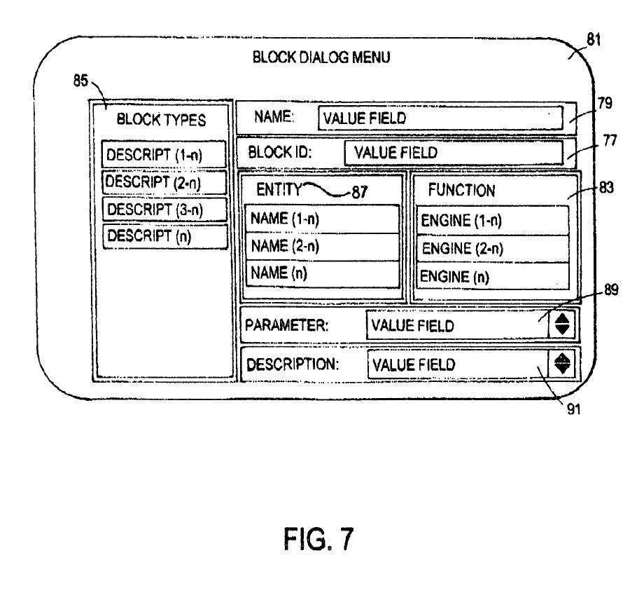

Each dynamic block 53 can be assigned by a user at the host server 13 and made available to users of the method and apparatus. These commonly required functions are available for a non-programming user in configuring the function of a dynamic block 53. Access to information on addition parameters is presented in one or more forms (FIG. 7) of a block dialog menu 81. Addition parameters values include but are not limited to: action or routines preformed within a block represented as block function 83; the classification of blocks available as block type 85; the content objects and element of content effected or resulting from the block entity 87; dependent variable to control the behavior of the block defined as block parameter 89; text added as a block description 91, to convey to other users what intent is behind the dynamic block 53 configuration and what it inputs and what results can be expected.

It is to be understood that the drawings and description matter are in all cases to be interpreted as merely illustrative of the principles of the invention, rather than as limiting the same in any way, since it is contemplated that various elements to achieve like results without departing from the spirit of the invention or the scope of the appended claims.

1. An apparatus used in conjunction with Internet Access to a Host computer for creating web site content nearly instantaneously based on the function and current data, comprising:
a host server including
an administrative application for composing design elements;
host storage for retaining the design elements;
a host database connected to the administrative application and to both the host data base and the host storage;
a local computer connected by the Internet to the host server, the local computer including:
an Internet browser for displaying HTML and other formatting languages composed by the server application;
a site designer including a block element containing attributes and
references as to design functions to provide the ability to modify site designs;
local storage for retention of modifications; and
administrative access for managing stored designs.

2. An apparatus according to claim 1 wherein the server application retrieves assigned properties including a template.

3. An apparatus according to claim 1 wherein the server application retrieves assigned properties including a template, each template containing an assembly of blocks that define attributes, functions and layout designations.

4. An apparatus according to claim 1 wherein the server application retrieves assigned properties including a template, each template containing an assembly of blocks that define specific attributes and layout designations.

5. An apparatus according to claim 1 wherein the server application retrieves assigned properties including template, each template containing at least one static block and each static block containing at least one dynamic block.

6. An apparatus according to claim 1 wherein the server application retrieves assigned properties including a template, each template containing at least one static block and each static block containing at least one dynamic block, each dynamic block being assigned an entity that offers a variety of functions associated with that specific dynamic block.

7. A method for creating a website utilizing the Internet from a host computer for a local computer:
selecting specific design elements;
storing a selection of design elements in the host computer;
transmitting the selected design elements to the local computer;
modifying the selected design elements on the local computer; and
storing in the local computer any modifications to the design elements.

8. A method according to claim 7 wherein the design elements define specific attributes, functions and layout designations.
